(19) United States
(12) Patent Application Publication
(10) Pub. No.: US 2011/0252618 A1
(43) Pub. Date: Oct. 20, 2011

(54) APPARATUS FOR REDUCING THE SIZE OF THE LOWER CONSTRUCTION CHAMBER OF A LASER SINTERING INSTALLATION

(75) Inventors: Wolfgang DIEKMANN, Waltrop (DE); Maik GREBE, Bochum (DE); Stefan ALTKEMPER, Dorsten (DE)

(73) Assignee: EVONIK DEGUSSA GmbH, Essen (DE)

(21) Appl. No.: 13/086,860

(22) Filed: Apr. 14, 2011

(30) Foreign Application Priority Data
Apr. 17, 2010 (DE) 202010005162.2

(51) Int. Cl. B23P 19/04

(52) U.S. Cl. 29/401.1; 29/650

(57) ABSTRACT

An apparatus for the reduction in size of the lower construction chamber of a laser sintering installation is provided. Also provided is a method to reduce the size of the lower construction chamber of a laser sintering installation by insertion of the apparatus of the invention. The invention thereby provides for reduction in the demand for material for specific laser sintering requirements. In addition, a new degree of sintering process control is obtained when the apparatus contains heating or cooling units.

### CROSS REFERENCE TO RELATED APPLICATIONS

This application claims priority to German Application No. 202010005162.2, filed Apr. 17, 2010, the disclosure of which is incorporated herein by reference in its entirety.

### BACKGROUND OF THE INVENTION

Laser sintering installations are commercially available in various designs which differ, inter alia, in terms of the volume of the construction chamber. However, a disadvantage of the available installations is that the volume of the construction chamber cannot be adapted variably to respective needs. As a result, the quantity of powder required in laser sintering installations cannot be reduced, even during the construction of very small parts in a small quantity. If the ratio of component volume to volume of the construction chamber worsens, the costs per component situation increase owing to the additional powder needed.

### SUMMARY OF THE INVENTION

It was therefore an object of the present invention to overcome the disadvantages of conventional laser sintering installations and make it possible in a given installation, to adapt the quantity of powder to the component size. This and other objects have been achieved by the present invention, the first embodiment of which includes an apparatus for reducing a size of a lower construction chamber of a laser sintering installation, comprising:

additional or new side walls insertable into a lower construction chamber of an existing laser sintering installation, thus reducing a lateral distance between at least one set of opposing sidewalls and

a new vertically adjustable construction platform sized to consume the reduced lateral distance between the additional or new side walls when inserted into the lower construction chamber of the existing laser sintering installation.

In a second embodiment, the present invention provides the apparatus as described above, wherein the new vertically adjustable construction platform is attached to an existing construction platform of the laser sintering installation.

In a third embodiment, the present invention provides the apparatus of the first embodiment, wherein the new vertically adjustable construction platform is a replacement for the existing construction platform of the installation.

In preferred embodiments, the present invention provides the apparatus of the first embodiment, wherein the additional or new side walls insertable into a lower construction chamber of an existing laser sintering installation comprise independently controlled heating or cooling units.

In a highly preferred embodiment, the present invention provides the apparatus of the first embodiment wherein the additional or new side walls insertable into a lower construction chamber of an existing laser sintering installation comprise a variable sliding and fixation mechanism, whereby the size of the construction chamber is optionally variable.

In a further preferred embodiment, the present invention provides a method for reducing the size of a lower construction chamber of a laser sintering installation, comprising: inserting additional or new walls into an existing lower construction chamber of a laser sintering installation to reduce a lateral distance between at least one set of opposing side walls, and adjusting the lateral size of a vertically adjustable construction platform to correspond to the reduced lateral distance of the inserted side walls.

### BRIEF DESCRIPTION OF THE DRAWINGS

FIG. 1 shows a simplified diagram of an existing lower construction chamber of a laser sintering installation with the size reduction apparatus according to the first embodiment of the invention inserted.

FIG. 2 shows a simplified side view of one variant of the first embodiment of the invention.

FIG. 3 shows a simplified side view of a second variant of the first embodiment of the invention.

FIG. 4 shows a simplified side view of a preferred embodiment of the invention.

FIG. 5 shows a simplified schematic diagram of a laser sintering installation of the first embodiment of the invention.

### DETAILED DESCRIPTION OF THE INVENTION

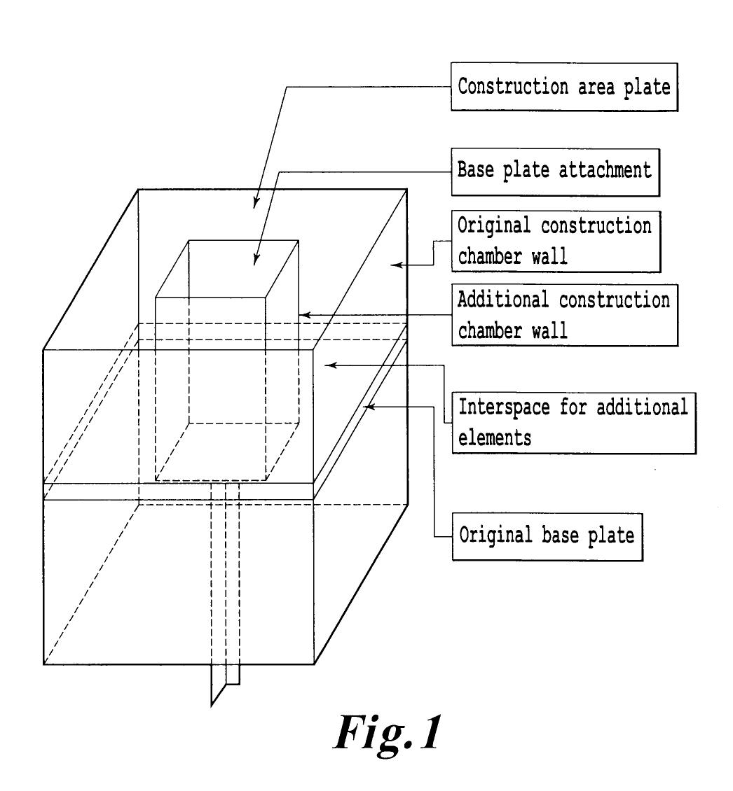

FIGS. 1 to 4 show the principle of the reduction in size of a construction chamber according to various embodiments of the invention. FIG. 5 shows a simplified schematic diagram of the laser sintering installation according to the first embodiment of the invention.

FIG. 1 is a simplified overall illustration of the present invention wherein additional or new side walls are inserted into a lower construction chamber of an existing laser sintering installation, thus providing additional or new side walls within the chamber and thereby reducing the lateral distance between at least one set of opposing sidewalls. A new vertically adjustable construction platform sized to consume the reduced lateral distance between the additional or new side walls when inserted into the lower construction chamber of the existing laser sintering installation is also placed in the chamber.

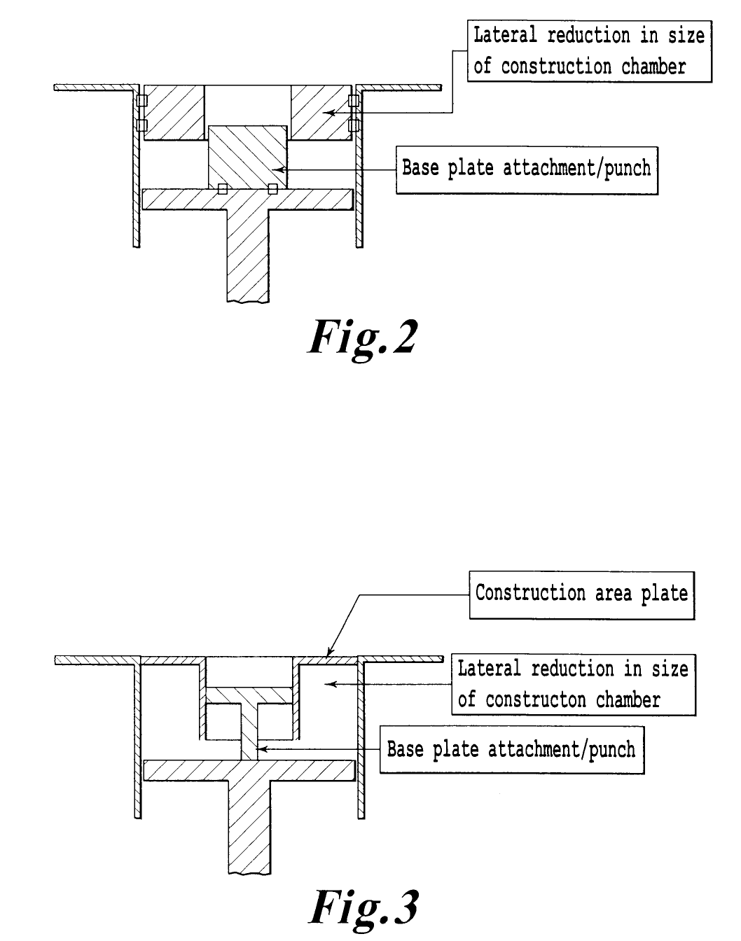

As shown in FIG. 2, the new construction platform may be a rigid base plate attachment placed on the original base plate of the lower construction chamber. Thus, by lowering the construction platform, the rigid attachment is lowered to the same extent, as a result of which the reduced surface area of the powder is likewise lowered by the layer thickness. The surface area available for the construction operation is determined by the dimensions of the additional construction chamber walls and of the base plate attachment.

Alternatively, as shown in FIG. 3, the laterally reduced size base plate may be a new inserted base plate which is elevated above the original base plate by a punch which rests on the original base plate.

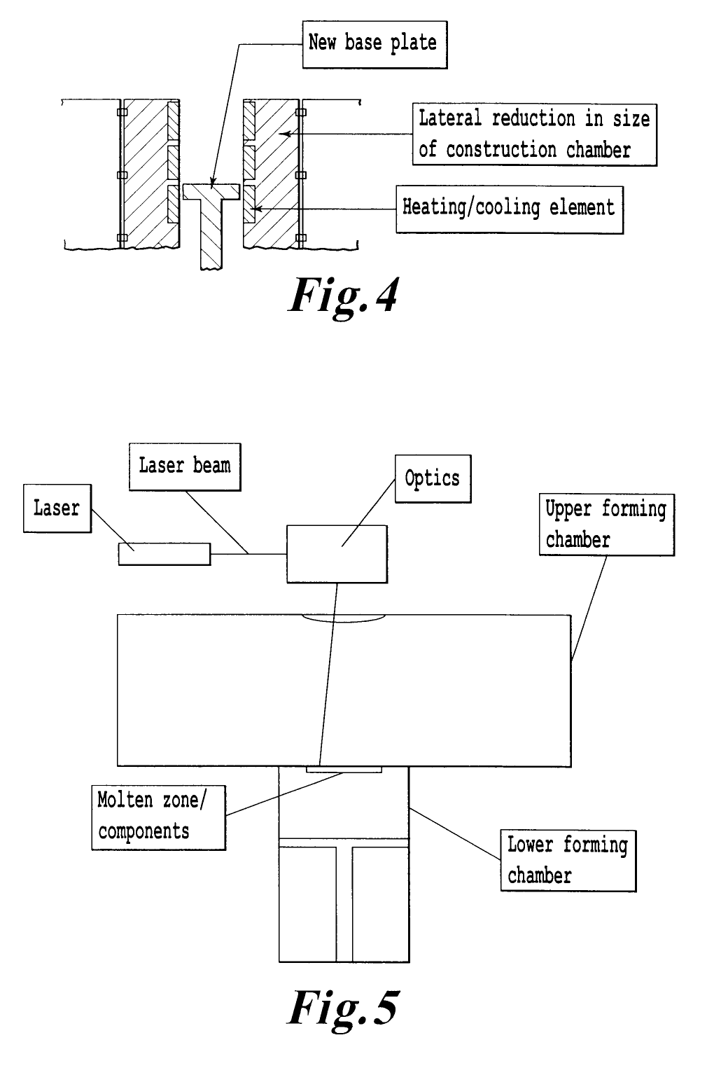

In the embodiment of the invention shown in FIG. 4, the original base plate of the construction chamber is replaced with a new construction platform, laterally sized to correspond to the lateral distance between the opposing inserted new or additional side walls. According to this embodiment, the new construction platform has the effect that the entire height of the construction chamber is available. Therefore, the inserted new or additional side walls are fitted accordingly over the entire height of the construction chamber.

The additional construction chamber walls may be connected fixedly to one another or alternatively be connected to one another by a sliding and fixing mechanism. The latter apparatus would have the advantage that the size of the construction chamber may be variably designed to reduce the size of the chamber. It would then only be necessary to adjust the size of the base plate attachment or new base plate to the designed size of the variable additional construction chamber walls.

A feature common to all of the possibilities shown here is that the new surface area of the construction chamber is determined for the respective reduction in size.

By reducing the size of the usable construction chamber, it is also possible to control the temperature along the z axis. Just like the heating and cooling elements, the temperature sensors can be installed on the new construction chamber wall. For this purpose, it is possible to make use of the spacing between the original construction container and the insert for size reduction. It is thereby possible to carry out the targeted temperature control, e.g. more uniform cooling, and also to control the temperature of the components in a targeted manner. More uniform cooling makes it possible, for example, to achieve a reduced tendency towards warpage. Furthermore, the temperature in the lower construction chamber can be adapted to the materials used. Primarily in the case of materials with a relatively high melting point, this is a necessary adaptation of the process. It is possible to establish various temperature zones by installing a plurality of separately controllable heating elements.

In preferred embodiments of the invention, as shown in FIG. 4, the additional or new side walls insertable into a lower construction chamber of an existing laser sintering installation may contain heating units, cooling units or units capable of both heating and cooling. Such units may be individually controlled so that the temperature of the reduces size chamber may be varied in the vertical direction. Advantageously, if thermocouples are included with cooling coils, the temperature of the reduced size chamber may be reduced more quickly and therefore the time to component removal may be reduced. Depending on the material used, a quicker cooling phase and the associated relatively low thermal loading may additionally allow for the renewed use of the powder.

Thus, the present invention provides for a new degree of freedom for temperature control in the lower construction chamber of a laser sintering installation. Depending on the temperature control method and the surface area of the construction chamber selected, component quality and the powder in the construction chamber may be thereby influenced.

The present invention provides a method for the reduction in size of the lower construction chamber of a laser sintering installation by insertion of the additional or new side walls which are appropriately sized to the respective need for construction space. According to the method of the invention a base plate attachment or a new base plate having the lateral size required for the reduced size of the inserted side walls is placed in the chamber. Thus, the claimed method provides for adjusting the size the laser sintering chamber and overcomes the above described disadvantages of a chamber limited to one size.

According to the various embodiments of the invention described above, the use of the existing construction platform reduces the available height to roughly below half the originally existing height. Alternatively, by exchanging the base plate, it is also possible to make use of the entire height of the construction chamber.

Advantageously, in all embodiments of the invention, existing installation control may be employed for laser sintering in the reduced size chamber.

For process reliability, good thermal insulation between the upper construction chamber to the lower construction chamber is advantageous. The construction area plate should therefore consist of a material which, in addition to good thermal stability, also has a good thermal insulation property. Materials such as heat-resistant polymers, fibre composite materials or refractory bricks are therefore suitable. By virtue of a constructive shape, such as a sandwich design, it is possible to further improve the thermal insulation or even to use materials with a poor insulation property, for example metals.

1. An apparatus for reducing a size of a lower construction chamber of a laser sintering installation, comprising:
additional or new side walls insertable into a lower construction chamber of an existing laser sintering installation, thus reducing a lateral distance between at least one set of opposing sidewalls and
a new vertically adjustable construction platform sized to consume the reduced lateral distance between the additional or new side walls when inserted into the lower construction chamber of the existing laser sintering installation.

2. The apparatus according to claim 1, wherein the new vertically adjustable construction platform is attached to an existing construction platform of the laser sintering installation.

3. The apparatus according to claim 1, wherein the new vertically adjustable construction platform is a replacement for the existing construction platform of the installation.

4. The apparatus according to claim 1, wherein the additional or new side walls insertable into a lower construction chamber of an existing laser sintering installation comprise independently controlled heating units.

5. The apparatus according to claim 1, wherein the additional or new side walls insertable into a lower construction chamber of an existing laser sintering installation comprise independently controlled cooling units.

6. The apparatus according to claim 1, wherein the additional or new side walls insertable into a lower construction chamber of an existing laser sintering installation comprise a variable sliding and fixation mechanism, whereby the size of the construction chamber is optionally variable.

7. The apparatus according to claim 1 wherein the lower construction chamber is thermally insulated from an upper construction chamber of the laser sintering installation.

8. A method for reducing the size of a lower construction chamber of a laser sintering installation, comprising:
inserting additional or new walls into an existing lower construction chamber of a laser sintering installation to reduce a lateral distance between at least one set of opposing side walls, and adjusting the lateral size of a vertically adjustable construction platform to correspond to the reduced lateral distance of the inserted side walls.

9. The method according to claim 8, wherein the adjustment of the lateral size of the vertically adjustable construction platform comprises:
a) inserting a base plate attachment having the reduced size corresponding to the reduced lateral distance between the inserted side walls; or
b) inserting a new base plate having the reduced size corresponding to the reduced lateral distance between the inserted side walls.

10. The method according to claim 8, wherein the inserted new or additional side walls comprise a variable sliding and fixation mechanism, whereby the size of the construction chamber is optionally variable.
